(19) United States
(12) Patent Application Publication
(10) Pub. No.: US 2004/0175018 A1
(43) Pub. Date: Sep. 9, 2004

(54) Information barrier for protection of personal information

(76) Inventors: Duncan W. MacArthur, Los Alamos, NM (US); Diana Langner, Los Alamos, NM (US)

Correspondence Address: UNIVERSITY OF CALIFORNIA, LOS ALAMOS NATIONAL LABORATORY, P.O. BOX 1663, MS A187, LOS ALAMOS, NM, 87545, US

(21) Appl. No.: 10/371,052

(22) Filed: Feb. 19, 2003

(51) Int. Cl. G06K 9/00; G01N 23/201; G06K 9/03

(52) U.S. Cl. 382/103; 382/141; 378/87; 382/309

(57) ABSTRACT

An information barrier for determining whether a person is concealing a dangerous weapon without exposing any sensitive or private information about the subject is disclosed. Within an enclosure, detector means obtain images of individuals, including images of concealed dangerous items, and output the images. Computing means receive the images for separating the concealed dangerous items from the personal image, and output a signal if an image of the concealed dangerous items is located, and display means output a non-sensitive indication of whether the concealed dangerous items have been detected.

The present invention generally relates to security technology, and more specifically to an information barrier that protects the personal information related to a subject during a security check. This invention was made with Government support under Contract No. W-7405-ENG-36 awarded by the U.S. Department of Energy. The Government has certain rights in the invention.

### FIELD OF THE INVENTION

### BACKGROUND OF THE INVENTION

After the horrific event of fall 2001, and the continued threat of terrorism throughout the world, security measures, particularly related to transportation security, have become much more stringent. The X-ray machines used for examining suitcases, briefcases and bags can be effective in detecting metallic objects, such as metal guns and knives. However, traditional X-ray technology is not as effective in detecting non-metallic objects, such as plastic explosives. Furthermore, traditional X-ray technology is not generally acceptable for screening people. Recently, technological advances have presented systems that are capable of screening people and packages for both metallic and non-metallic items.

This technology, however effective as it is in imaging both metallic and non-metallic items, is necessarily quite intrusive. One such system manufactured by AS&E uses back-scatter X-ray to produce quite detailed images. Because of this, many details of a screened person's anatomy are displayed along with any weapons or drugs hidden under his clothing. Clearly, this presents a serious violation of a person's right to privacy. Use of such a system only is currently warranted in specific legally justified applications. This, and other, sophisticated imaging technologies have similarly have not found wide application to human subjects in spite of their obvious benefits in combating terrorism and drug trafficking.

A solution that would allow these technologies to be utilized more effectively is an information barrier. As used herein, an information barrier is a combination of technology and procedures designed to protect sensitive or personal information from display or storage, while at the same time allowing the transmission and display of certain permitted and non-sensitive information. However, along with the protection of sensitive information, an information barrier must also enable an inspector to authenticate the accuracy of the information. It is necessary that any information barrier allow the inspector to be confident that the simple output of the system is accurately representative of the complex and sensitive information obtained from the imaging system. The public needs to be assured that their sensitive personal information and images are neither displayed nor archived. The goals of protecting sensitive information and detecting illicit material are often competing.

The present invention addresses this problem by providing an information barrier that allows inspectors to reach conclusions about images that contain personal information without revealing any of the personal information. The information barrier taught herein filters the information garnered by an appropriate sensor and provides a simple “pass/fail” to the inspector.

It is therefore an object of the present invention to provide an information barrier that protects a subject's personal information from being displayed or archived.

It is another object of the present invention to provide an information barrier that allows an inspector access only to a pass or fail indication.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, an information barrier for preventing access to personal sensitive information in personnel screening applications comprises

an enclosure, and detector means located in the enclosure for obtaining images of individuals, including images of concealed dangerous items, and for outputting the images. Computing means receive the images for identifying any concealed dangerous items in the personal image, and output a signal if an image of the concealed dangerous items is located, and display means output a non-sensitive indication of whether the concealed dangerous items have been detected.

In a further aspect of the present invention and in accordance with its principles and purposes, a method of determining whether or not a subject is concealing dangerous items comprises the steps of obtaining an image of a subject; analyzing the image for the dangerous items; and outputting a non-sensitive indication of whether the dangerous items have been detected.

### BRIEF DESCRIPTION OF THE DRAWINGS

The accompanying drawing, which is incorporated in and forms a part of the specification, illustrates an embodiment of the present invention and, together with the description, serve to explain the principles of the invention. In the drawing:

FIG. 1 is a block diagram of an embodiment of the present invention, which illustrates its primary components.

FIG. 2 is a schematical diagram of the power interrupt circuit employed in the present invention.

### DETAILED DESCRIPTION

The present invention provides accurate screening for dangerous items without compromising the privacy of the interrogated individuals. Understanding of the present invention will be aided through reference to the drawings.

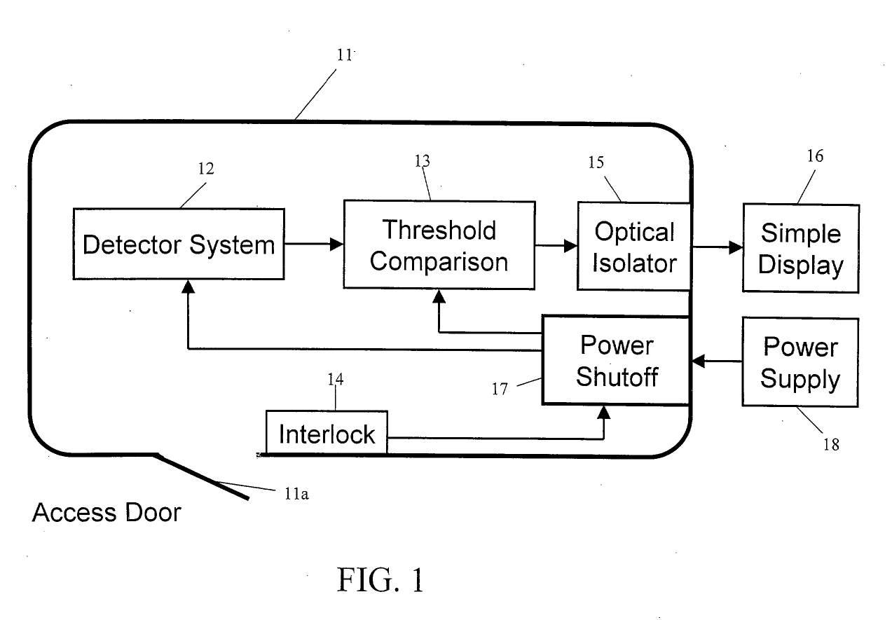

Turning first to FIG. 1, there can be seen a block diagram of the primary components of the present invention. As seen, enclosure 11 provides secure protection for any sensitive personal information that might be gleaned from an individual. This information, obtained by detector system 12, is separated from the obtained image in computer 13, where image-detecting software in computer 13 makes a threshold comparison in checking the obtained image for the image of concealed weapons. If an image of a weapon is discovered, only this information is output, so that any private aspects of the entire image are not disclosed. Computer 13 is loaded with and runs image comparison software that can determine within an image of a person if a dangerous weapon is concealed. One such software program is the “Genie” program developed at Los Alamos National Laboratory.

Detector system 12 can be any effective personal imaging device that can output a digital image to computer 13. One such device is manufactured by American Science & Engineering of Billerica, Mass. and Santa Clara, Calif., and is marketed under the name: Bodysearch.

Enclosure 11 includes access door 11a, which allows access into enclosure 11 so that maintenance or other function can be performed on imaging systems 12 and computer 13. During normal operation, the invention operates with access door 11a closed. However, door interlock 14 causes power to be interrupted so that all memory in computer 13 is erased upon the opening of access door 11a. This is to insure that no viewing of private images can be accomplished by those entering enclosure 11. In this regard, computer 13 has no hard drive, and only contains volatile memory. However, with the permission of any subjects, power can be restored after a period of time with access door 11a open, as will be explained more fully below. This restoration of power allows system testing and evaluation to occur using informed and consenting test subjects.

Raw images of individuals generated by imaging systems 12 are passed directly to computer 13 where the raw image is processed and compared with characteristics of weapons. This raw data at all times remains within enclosure 11, securely away from observation by unauthorized persons. After computer 13 completes analyzing the raw images, it outputs a yes/no signal through optical isolator 15 to a display 16 that has lights or other indicia of the yes/no output of computer 13. This yes/no output would inform inspectors whether there is an indication the subject of the imaging might be concealing a weapon and requires further inspection. All of this is accomplished without the display of any images that might violate an individual's privacy. Since display 16 is made up of lights or other “yes/no” indicators, display 16 is completely incapable of displaying any of the personal images. This lack of capability provides the final, graphic, “proof” to the individual being screened that no personal images can be displayed. Additionally, optical isolator 15 prevents any intrusion into computer 13 from outside enclosure 11.

Electrical power supply to the present invention is provided through power shutoff 17, a control circuit that disconnects power supply 18 when door interlock 14 operates upon the opening of access door 11a. As previously described, this is to prevent both unauthorized viewing of the current image as well as clandestine archiving of previous images. Although only a single image is stored in the computer at any time, this interlock provides extra, and more visible assurance that all images have been deleted as access door 11a is opened.

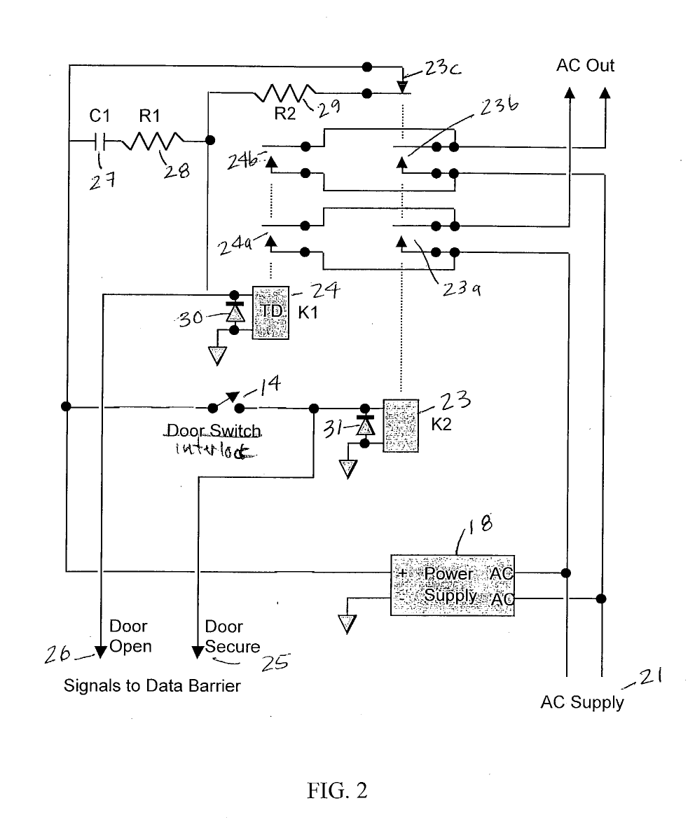

Power shutoff 17 is shown in schematic form in FIG. 2. Here, alternating current (AC) supply 21 is connected to power supply 18, which serves to rectify the AC and produce a direct current (DC) output. Power supply 18 supplies power to the coils of relays 23, 24. When door interlock 14 is closed, indicating that access door 11a (FIG. 1) is closed, relay 23 is energized, closing contacts 23a, 23b, and supplying AC power to detector system 12 and computer 13 (FIG. 1). However, should access door 11a open, door interlock 14 would open and disconnect power from detector system 12 and computer 13. Upon this occurrence, normally closed contact 23c again closes and supplies DC power to time delay relay 24. After a predetermined period of time, time delay relay 24 would close, restoring AC power, but only after all information in the volatile memory of computer 13 has been destroyed.

When power is being supplied through contacts 23a, 23b, interlock 14 is closed and the entire system is secure. Output signal 25 indicates a secure access door 11a, being derived directly from the coil of relay 23. Similarly, if the invention is operating with access door 11a open, power will be supplied through contacts 24a, 24b, and output signal 26 will indicate the door open indication using power from the coil of relay 24.

Capacitor 27 serves to insure that AC power is maintained as door 11a and interlock 14 are being closed. Without the operation of capacitor 27, relay 23 would be energized and relay 24 de-energized at the same time. Should relay 24 operate more quickly than relay 23, power to computer 13 could be lost for a brief period of time, destroying any images obtained while door 11a was open. Resistors 28, 29 serve to limit the current through relay contacts 23c during the transition between open door and closed door. Diodes 30, 31 shunt to ground any reverse EMF generated in the coils of relays 23, 24 when they are being de-energized.

The fact that all image memory is erased from computer 13 whenever access door 11a is opened should serve to allay the fears of the public that any private information could be accessed. It should be emphasized that all functions of the present invention can be accomplished with a single computer as computer 13. This also should serve to generate confidence in subjects that their right to privacy is not being invaded by being imaged by the present invention.

The foregoing description of the embodiments of the invention has been presented for purposes of illustration and description. It is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An information barrier for preventing access to personal sensitive information in personnel screening applications comprising:
an enclosure;
detector means located in said enclosure for obtaining images of individuals, including images of concealed dangerous items, and outputting said images;
computing means receiving said images for separating said concealed dangerous items from the personal image, and outputting a signal if an image of said concealed dangerous items is located; and
display means for outputting a non-sensitive indication of whether said concealed dangerous items have been detected.

2. The information barrier described in claim 1, wherein said computing means contains only volatile memory.

3. The information barrier described in claim 2, further comprising a door in said enclosure, said door having an interlock to interrupt electrical power to said computing means upon the opening of said door.

4. A method of determining whether or not a subject is concealing dangerous items comprises the steps of:
obtaining an image of a subject;
analyzing said image for said dangerous items;
outputting a non-sensitive indication of whether said dangerous items have been detected.
